(19) United States
(12) Patent Application Publication
(10) Pub. No.: US 2021/0221140 A1
(43) Pub. Date: Jul. 22, 2021

(54) FLUID EJECTION DEVICE INCLUDING PRINT AND SERVICE NOZZLES, AND METHOD FOR PRINTING

(71) Applicant: HEWLETT-PACKARD DEVELOPMENT COMPANY, L.P., Fort Collins, CO (US)

(72) Inventor: Arun K Agarwal, Corvallis, OR (US)

(73) Assignee: HEWLETT-PACKARD DEVELOPMENT COMPANY, L.P., Fort Collins, CO (US)

(21) Appl. No.: 16/095,896

(22) PCT Filed: Jul. 13, 2016
(86) PCT No.: PCT/US2016/042022

§ 371 Date: Oct. 23, 2018

(51) Int. Cl. B41J 2/165

(52) U.S. Cl. CPC B41J 2/16552

(57) ABSTRACT

According to examples, an ejection nozzle may include an ejection nozzle orifice to eject printing material, and a service nozzle may include a service nozzle orifice to eject service fluid.

### BACKGROUND INFORMATION

In some printing systems, a fluid ejection device is a component that ejects and/or deposits printing material onto a substrate or media during printing. An example of a substrate includes paper. The printing material may be ejected onto the substrate in the form of drops to generate a printed substrate.

### BRIEF DESCRIPTION OF DRAWINGS

Features of the present disclosure are illustrated by way of examples shown in the following figures. In the following figures, like numerals indicate like elements, in which:

FIG. 1 illustrates a top view of a fluid ejection device including a plurality of ejection nozzles including circular ejection nozzle orifices and corresponding printing material ejectors, and a plurality of service nozzles including circular service nozzle orifices and corresponding service fluid ejectors, according to an example of the present disclosure;

FIG. 2 illustrates an environment including the fluid ejection device of FIG. 1, according to an example of the present disclosure;

FIG. 3 illustrates various aspects of printing material crusting on a surface of the fluid ejection device, according to an example of the present disclosure;

FIG. 4 illustrates a top view of the fluid ejection device of FIG. 1 including a plurality of ejection nozzles including circular ejection nozzle orifices and a plurality of service nozzles including oval service nozzle orifices, according to an example of the present disclosure;

FIG. 5 illustrates a top view of the fluid ejection device of FIG. 1 including a plurality of ejection nozzles including circular ejection nozzle orifices and a plurality of service nozzles including rectangular service nozzle orifices on one side of a service fluid chamber, according to an example of the present disclosure;

FIG. 6 illustrates a top view of the fluid ejection device of FIG. 1 including a plurality of ejection nozzles including circular ejection nozzle orifices and a plurality of service nozzles including circular service nozzle orifices disposed at an extended distance from a service fluid chamber and on one side of the service fluid chamber, according to an example of the present disclosure; and

FIG. 7 illustrates a flowchart of a method for printing, according to an example of the present disclosure.

### DETAILED DESCRIPTION

For simplicity and illustrative purposes, the present disclosure is described by referring mainly to examples thereof. In the following description, details are set forth in order to provide an understanding of the present disclosure. It will be readily apparent however, that the present disclosure may be practiced without limitation to these details. In other instances, methods and structures apparent to one of ordinary skill in the art have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

According to examples of the present disclosure, a fluid ejection device and a method of operation thereof are disclosed herein. In some examples, the fluid ejection device may be in the form of a printhead, or include a printhead. In some examples, the fluid ejection device may correspond to a component of a printing system. In some examples, the fluid ejection device may be coupled to a fluid container such that the fluid ejection device and fluid container may be an integrated device, such as a printer cartridge. Some examples may comprise a plurality of fluid ejection devices as described herein where such plurality may be arranged in an array, such as a page-wide array. The fluid ejection device may be used with printing systems that include fixed and/or movable printer cartridges. Examples of printing systems that include fixed printer cartridges include fixed array printing systems, and other such printing systems. Such fixed array printing systems may include one or several printer cartridges that are disposed in a fixed arrangement relative to a movable substrate. Examples of printing systems that include movable printer cartridges include desktop inkjet printers, and other such printers that may be referred to as scanning-head printing systems. Such inkjet printers may include one or several printer cartridges that are disposed in a movable arrangement relative to a movable substrate.

The device and method disclosed herein may provide for the dispensing of a service fluid to cool a surface of the fluid ejection device, reduce drying (i.e., crusting) of printing material on the surface of the fluid ejection device, and spread on the surface of the fluid ejection device. The service fluid may thus control and eliminate crusting on the surface of the fluid ejection device adjacent to the ejection nozzle orifice, and allow for sustained printing without service intervention for extended periods of time.

The service fluid may include a fluid such as water and a surfactant mixture. Alternatively, the service fluid may include any type of solvent and/or cleaning fluid. For a service fluid that includes water, surfactants may be added to modify the surface tension of water so as to create a relatively low surface tension service fluid (e.g., 5-20 dynes, as opposed to 72 dynes for water) that readily spreads into a thin film on the surface of the fluid ejection device. A surfactant may include any compound that lowers the surface tension (or interfacial tension) between two liquids or between a liquid and a solid. Surfactants may act as detergents, wetting agents, emulsifiers, foaming agents, and dispersants.

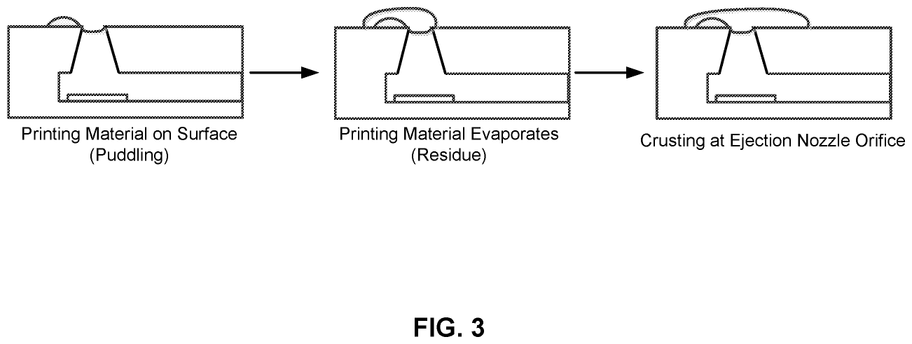

The printing material, as used herein, may include any type of ink, including latex inks, that are used with the fluid ejection device. With respect to latex inks, such inks are designed to film form with heat and curing to provide a high durability print on non-porous synthetic substrates such as vinyl. In addition, printing material, as used herein comprises consumable fluids as well as other consumable materials. Printing material may comprise ink, toner, fluids, powders, colorants, varnishes, finishes, gloss enhancers, binders, and/or other such materials that may be utilized in a printing process. Referring to FIG. 3 which illustrates various aspects of printing material crusting on a surface of the fluid ejection device, residual printing material that resides on the surface of the fluid ejection device may dry and crust, thus blocking the ejection nozzles and interfering with drop ejection. The crusting may result from the building of residual puddles of printing material left behind as a result of consecutive droplet jetting, where the residual puddles may dry out due to air flow and high temperatures, thus leaving behind a nearly-solid residue that can block the ejection nozzles.

As disclosed herein, the device and method disclosed herein may provide for the dispensing of the service fluid to cool the surface of the fluid ejection device. With respect to cooling of the surface of the fluid ejection device, with the use of water as the service fluid, the high specific heat capacity of water may provide for the cooling the surface of the fluid ejection device in addition to reduction of drying of the printing material.

As disclosed herein, the device and method disclosed herein may include the use of service nozzles disposed adjacent ejection nozzles, where the service nozzles deliver and dispense service fluid. A service fluid ejector associated with a service nozzle may be configured such that the service fluid is pushed out of the service nozzle orifice with just enough energy so as to be ejected from the service nozzle orifice. For example, a service fluid ejector associated with a service nozzle may include a relatively small resistor that is 0.2-0.6 times the diameter of the service nozzle orifice (i.e., a significantly smaller ratio relative to a fluid ejector (e.g., a resistor, a piezoelectric device, etc.) that is used to eject droplets from printing materials, where a printing material ejector to an ejection nozzle orifice diameter ratio may be in the range of 0.8-2.0). Thus, the service fluid may readily spread on the surface of the fluid ejection device without being ejected onto a print substrate. Effectively, the service fluid is “puddled”, and further spreads to adjacent ejection nozzles as a thin film so as to keep the residual printing material wet until such period of time when the surface of the fluid ejection device is ready to be physically serviced (e.g., on the order of 10 s of minutes to hours). The service fluid ejector may thus be sized to push the service fluid out of the service nozzle orifice with a low energy drive bubble such that no drop is ejected onto the print substrate.

The service nozzle orifices of the service nozzles may include circular or non-circular shapes, different range of sizes, different range of resolutions, and different distances from the ejection nozzles. For example, the shape and aspect ratio of the service nozzle and/or the service nozzle orifice may be varied to adjust the service fluid resistance appropriately for dispensing and applying the service fluid.

For example, a water-based service fluid with wetting additives may be in the viscosity range of 1-1.5 centipois (cP). The service nozzle shape may include shapes such as oval, hourglass, rectangular, racetrack, cross, star, etc. For example, the service nozzle orifice may be constructed of a shape that includes low resistance such as that achieved by a square shaped service nozzle orifice that allows the service fluid to exit the service nozzle orifice with minimal resistance.

The resolution (i.e., based on the size of the service nozzle orifice) of a set of service nozzles may be adjusted as needed, and may vary from low resolution (e.g., x service nozzle orifices per specified distance) up to the full capability of the fluid ejection device (e.g., y service nozzle orifices per specified distance, where y is greater than x).

The service nozzles may include larger openings that span multiple service fluid ejectors.

Further, the distance of a service nozzle orifice to an ejection nozzle orifice may be adjusted, for example, by providing the service fluid ejector and the service nozzle orifice much closer to the ejection nozzle orifice by making a relatively long shelf to provide a path for movement of the service fluid from the corresponding service fluid chamber.

The device and method disclosed herein may eliminate or reduce the need to physically wipe the surface of the fluid ejection device. Thus, by eliminating or reducing the need to physically wipe the surface of the fluid ejection device, printing speed may be increased as the time associated with a wiping event may now be allocated to continued printing on a substrate. Moreover, for printing systems that include fixed printer cartridges and movable and/or fixed substrates, as well as for printing systems that include movable printer cartridges and movable substrates, productivity and print quality remains unaffected as the surface of the fluid ejection device remains free of crusted printing material. In this regard, for printing systems that include fixed printer cartridges that cannot be accessed frequently for wiping and other types of servicing, productivity and print quality remains unaffected as the surface of the fluid ejection device remains free of crusted printing material.

Some examples described herein may be implemented in printing systems in which a printing material may be distributed on a build layer of build material such that these examples may perform a layer-wise additive manufacturing process. Examples of such layer-wise additive manufacturing printing systems may be referred to as three-dimensional printers. In such examples, fluid ejection devices as described herein may selectively distribute printing materials on a layer of powder-based build material to facilitate fusion of portions of such build material. As will be appreciated, each layer may correspond to a cross-section of a three-dimensional object to be formed. Sequentially layering and fusing layers of build material on top of previous layers may facilitate generation of the three-dimensional object. In examples described herein, a build material may include a powder-based build material, where the powder-based build material may comprise wet and/or dry powder-based materials, particulate materials, and/or granular materials. For three-dimensional printers, the ejected fluids may be referred to as agents that increase energy absorption or decrease energy absorption of the media upon which the fluid is distributed. For two-dimensional printers, bonding agent, glosses, etc., may be applied as disclosed herein.

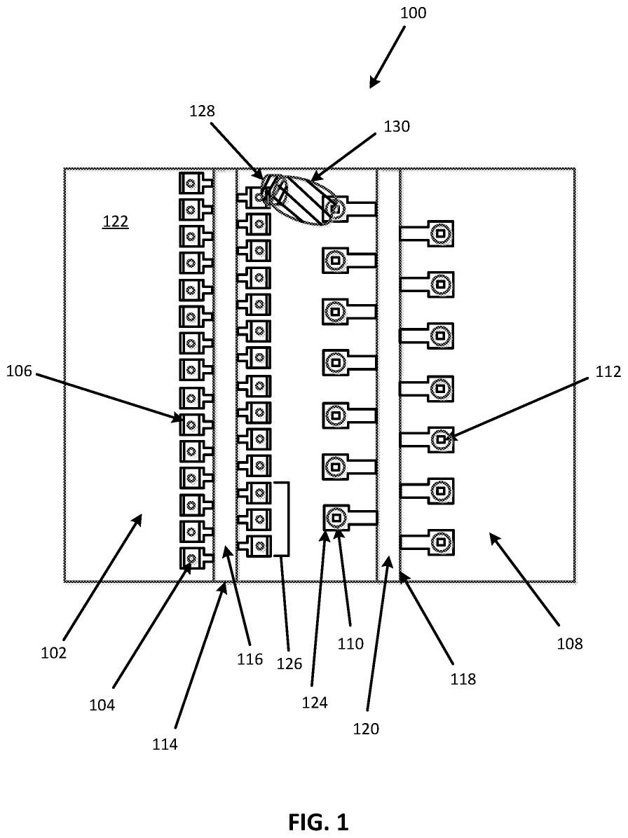

FIG. 1 illustrates a top view of a fluid ejection device 100 including a plurality of ejection nozzles 102 including circular ejection nozzle orifices 104 and corresponding printing material ejectors 106, and a plurality of service nozzles 108 including circular service nozzle orifices 110 and corresponding service fluid ejectors 112, according to an example of the present disclosure.

Referring to FIG. 1, each ejection nozzle of the plurality of ejection nozzles 102 may include an ejection nozzle orifice in communication with a corresponding printing material chamber 114. The printing material chamber 114 may supply printing material 116 to be ejected from the ejection nozzle orifice of a corresponding ejection nozzle when the printing material 116 is heated by a corresponding printing material ejector (e.g., the corresponding one of the printing material ejectors 106).

Each service nozzle of the plurality of service nozzles 108 may include a service nozzle orifice in communication with a corresponding service fluid chamber 118. The service fluid chamber 118 may supply service fluid 120 to be ejected from the service nozzle orifice of a corresponding service nozzle when the service fluid 120 is heated by a corresponding service fluid ejector (e.g., the corresponding one of the service fluid ejectors 112). The plurality of service nozzles 108 may be positioned adjacent the plurality of ejection nozzles 102 to enable mixing of the service fluid 120 with the printing material 116 on a surface 122 of the fluid ejection device 100. For example, as illustrated in FIG. 1, assuming that the area 128 represents the printing material 116 on the surface 122 of the fluid ejection device 100, the area 130 that represents the service fluid 120 may mix with the area 128 on the surface 122 of the fluid ejection device 100. In this manner, other areas such as the area 130 of the service fluid 120 may mix with further areas such as the area 128 on the surface 122 of the fluid ejection device 100.

The service fluid ejector (e.g., one of the service fluid ejectors 112) may be configured to eject the service fluid 120 from the service nozzle orifice of the corresponding service nozzle at a service fluid ejection velocity that is less than a printing material ejection velocity associated with ejection of the printing material 116 by the printing material ejector (e.g., one of the printing material ejectors 106).

According to examples, the service fluid ejector (e.g., one of the service fluid ejectors 112) may include a square configuration as shown in FIG. 1. The service nozzle orifice of the corresponding service nozzle may include a circular configuration as shown in FIG. 1. For the service fluid ejector including a square configuration, and the service nozzle orifice including a circular configuration, a ratio of a side of the service fluid ejector to a diameter of the service nozzle orifice may be between approximately 0.2 to approximately 0.8. Thus, the service fluid ejector may be relatively smaller compared to the service nozzle orifice. Alternatively, the service fluid ejector may be of a similar size or relatively larger compared to the service nozzle orifice, with an energy output of the service fluid ejector being controlled accordingly to eject the service fluid 120 as disclosed herein.

According to examples, a size of the service nozzle orifice of the corresponding service nozzle may be larger compared to a size of the ejection nozzle orifice of the corresponding ejection nozzle. For example, as shown in FIG. 1, a size of the service nozzle orifice of the corresponding service nozzle may be larger compared to a size of the ejection nozzle orifice of the corresponding ejection nozzle. Alternatively, a size of the service nozzle orifice of the corresponding service nozzle may be the same as a size of the ejection nozzle orifice of the corresponding ejection nozzle.

According to examples, a service nozzle of the plurality of service nozzles 108 may be assigned to a set of the plurality of ejection nozzles 102 to cool the surface 122 of the fluid ejection device 100 adjacent to the set of the plurality of ejection nozzles 102. Alternatively or additionally, a service nozzle of the plurality of service nozzles 108 may be assigned to a set of the plurality of ejection nozzles 102 to reduce drying of the printing material 116 that remains on the surface 122 of the fluid ejection device 100 adjacent to the set of the plurality of ejection nozzles 102. The set of the plurality of ejection nozzles 102 may include greater than one ejection nozzle of the plurality of ejection nozzles 102. For example, as shown in FIG. 1, the service nozzle 124 of the plurality of service nozzles 108 may be assigned to a set 126 of the plurality of ejection nozzles 102 to cool the surface 122 of the fluid ejection device 100 adjacent to the set 126 of the plurality of ejection nozzles 102, and/or reduce drying of the printing material 116 that remains on the surface 122 of the fluid ejection device 100 adjacent to the set 126 of the plurality of ejection nozzles 102. In this manner, a service nozzle of the plurality of service nozzles 108 may broadly supply the service fluid 120 for eliminating or reducing crusting of the printing material 116 adjacent to the set 126 of the plurality of ejection nozzles 102.

According to examples, instead of a single service nozzle orifice for a corresponding service fluid ejector, a plurality of the service nozzle orifices 110 may be associated with a single large service fluid ejector (or a reduced number of service fluid ejectors 112), and vice-versa.

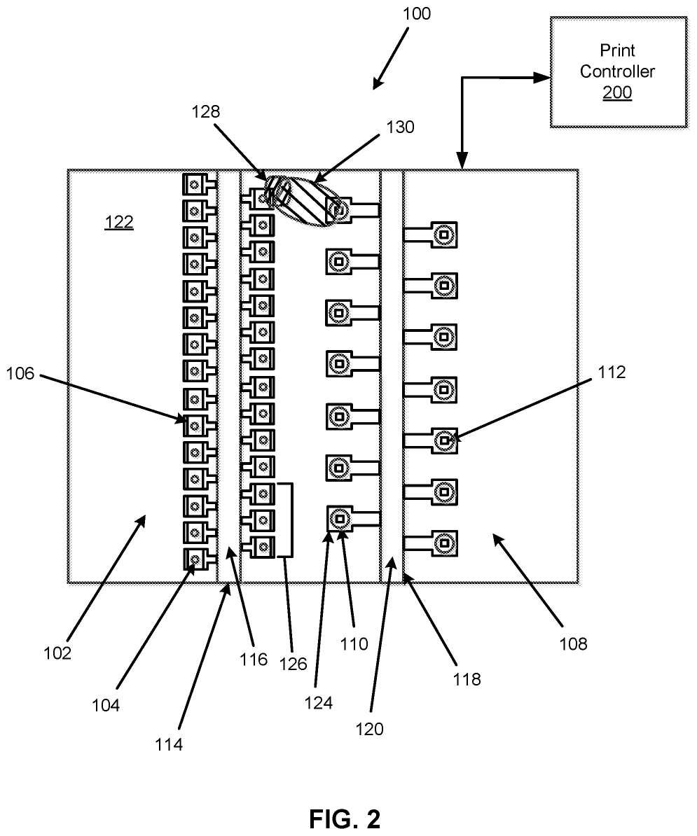

FIG. 2 illustrates an environment including the fluid ejection device 100, according to an example of the present disclosure.

Referring to FIGS. 1 and 2, a print controller 200 may control operation of various components of the fluid ejection device 100. According to an example, the print controller 200 may be a part of the fluid ejection device 100. Alternatively, the print controller 200 may be disposed separately from the fluid ejection device 100 as shown in FIG. 2.

The print controller 200 may control operation of the printing material ejectors 106, the service fluid ejectors 112, and any other components associated with operation of the ejection nozzles 102 and/or the service nozzles 108. For example, the print controller 200 may control operation of the printing material ejectors 106, the service fluid ejectors 112 to eject the service fluid 120 simultaneously at every ejection of the printing material 116, or at other specified intervals associated with ejection of the printing material 116.

In some examples, the elements (e.g., the print controller 200) of the fluid ejection device 100 may be machine readable instructions stored on a non-transitory computer readable medium. In this regard, the fluid ejection device 100 may include a non-transitory computer readable medium. In some examples, the elements of the fluid ejection device 100 may be hardware or a combination of machine readable instructions and hardware.

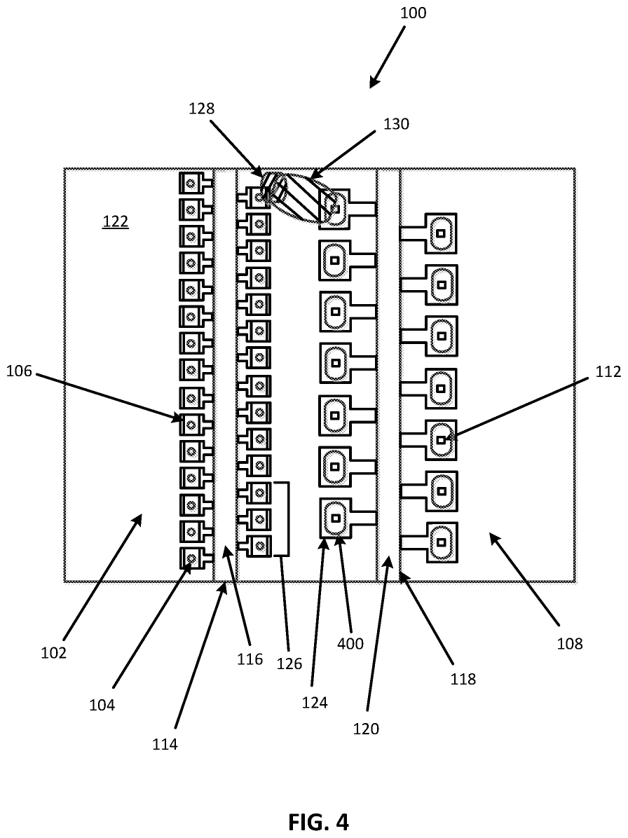

FIG. 4 illustrates a top view of the fluid ejection device 100 including a plurality of ejection nozzles 102 including circular ejection nozzle orifices 104 and a plurality of service nozzles 108 including oval service nozzle orifices 400, according to an example of the present disclosure. For example, as shown in FIG. 4, a shape of the service nozzle orifice of the corresponding service nozzle may be different (e.g., oval) compared to a shape of the ejection nozzle orifice of the corresponding ejection nozzle. The oval shape of the service nozzle orifices 400 may provide for increased ejection and further control of ejection of the service fluid 120.

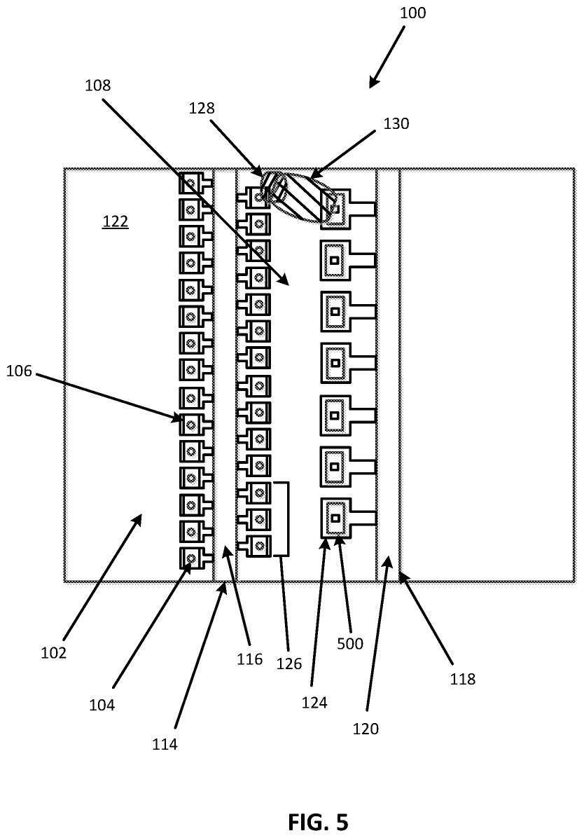

FIG. 5 illustrates a top view of the fluid ejection device 100 including a plurality of ejection nozzles 102 including circular ejection nozzle orifices and a plurality of service nozzles 108 including rectangular service nozzle orifices 500 on one side of the service fluid chamber 118, according to an example of the present disclosure. For example, as shown in FIG. 5, a shape of the service nozzle orifice of the corresponding service nozzle may be different (e.g., rectangular) compared to a shape of the ejection nozzle orifice of the corresponding ejection nozzle. Further, the service nozzle orifices 500 may be disposed on one side of the service fluid chamber 118, as opposed to on both sides of the service fluid chamber 118. The rectangular shape of the service nozzle orifices 500 may provide for increased ejection and further control of ejection of the service fluid 120.

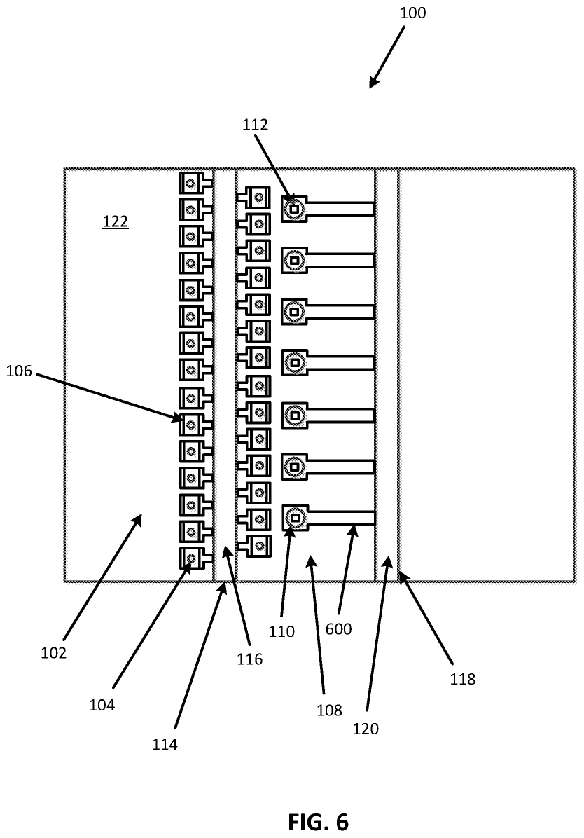

FIG. 6 illustrates a top view of the fluid ejection device 100 including a plurality of ejection nozzles 102 including circular ejection nozzle orifices 104 and a plurality of service nozzles 108 including circular service nozzle orifices 110 disposed at an extended distance 600 from the service fluid chamber 118 and on one side of the service fluid chamber 118, according to an example of the present disclosure. For example, as shown in FIG. 6, the service nozzle orifices 110 may be disposed at a closer distance to the ejection nozzle orifices 104, compared to the examples of FIGS. 1, 2, 4, and 5. In this manner, the distance 600 of the adjacent service nozzle orifices 110 may be adjusted, for example, by providing the service fluid ejectors 112 and the service nozzle orifices 110 much closer to the ejection nozzle orifices 104 by making a relatively long shelf (i.e., defined by the distance 600) to provide a path for the service fluid 120 from the corresponding service fluid chamber 118.

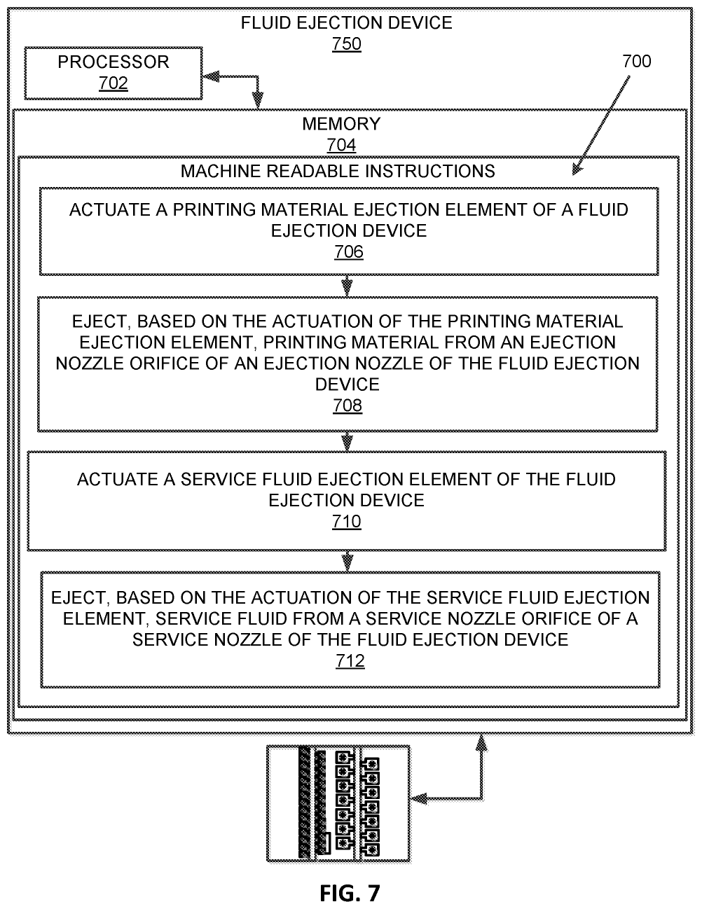

FIG. 7 illustrates a flowchart of a method 700 for printing, according to an example of the present disclosure. The method 700 may be implemented on a fluid ejection device 750, similar to the fluid ejection device 100 as described above with reference to FIGS. 1, 2, and 4-6 by way of example and not limitation. The method 700 may be practiced in other device. In addition to showing the method 700, FIG. 7 shows hardware of the fluid ejection device 750 that may execute the method 700. The hardware may include a processor 702, and a memory 704 storing machine readable instructions that when executed by the processor cause the processor to perform the steps of the method 700. The memory 704 may represent a non-transitory computer readable medium. For the example of FIG. 7, the fluid ejection device 750 may control operation of ejection nozzles and service nozzles illustrated separately at the bottom of FIG. 7. Alternatively, the fluid ejection device 750 may control operation of ejection nozzles and service nozzles, which are components of the fluid ejection device 750.

The processor 702 of FIG. 7 may include a single or multiple processors or other hardware processing circuit, to execute the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory). The memory 704 may include a RAM, where the machine readable instructions and data for a processor may reside during runtime.

Referring to FIGS. 1, 2, and 4-7, and particularly to the method 700 shown in FIG. 7, at block 706, the method 700 may include actuating a printing material ejection element (e.g., one of the printing material ejectors 106) of the fluid ejection device 100.

At block 708, the method 700 may include ejecting, based on the actuation of the printing material ejection element, printing material 116 from an ejection nozzle orifice of an ejection nozzle of the fluid ejection device. The ejection of the printing material 116 may occur at a printing material ejection velocity.

At block 710, the method 700 may include actuating a service fluid ejection element (e.g., one of the service fluid ejectors 112) of the fluid ejection device.

At block 712, the method 700 may include ejecting, based on the actuation of the service fluid ejection element, the service fluid 120 from a service nozzle orifice of a service nozzle of the fluid ejection device. The ejection of the service fluid 120 may occur at a service fluid ejection velocity. The service fluid ejection velocity may be less than the printing material ejection velocity to cause the ejected service fluid 120 to cool the surface 122 of the fluid ejection device, and/or reduce drying of the printing material 116 on the surface 122 of the fluid ejection device.

According to examples, for the method 700, as illustrated in FIG. 1, the service fluid ejection element may include a square configuration, and the service nozzle orifice may include a circular configuration. The method 700 may further include reducing the service fluid ejection velocity by using the service fluid ejection element and the service nozzle orifice for which a ratio of a side of the service fluid ejection element to a diameter of the service nozzle orifice is between approximately 0.2 to approximately 0.8.

According to examples, for the method 700, as illustrated in FIGS. 4 and 5, actuating the service fluid ejection element of the fluid ejection device may further include actuating the service fluid ejection element of the fluid ejection device to cause the service fluid 120 to eject from the service nozzle orifice that is shaped differently (e.g., oval, rectangular, etc.) compared to a shape of the ejection nozzle orifice, and spread on the surface 122 of the fluid ejection device.

According to examples, for the method 700, as illustrated in FIGS. 1, 4, and 5, actuating the service fluid ejection element of the fluid ejection device may further include actuating the service fluid ejection element of the fluid ejection device to cause the service fluid to eject from the service nozzle orifice that includes a larger size (e.g., see FIGS. 1, 2, and 4-6) compared to a size of the ejection nozzle orifice, and spread on the surface 122 of the fluid ejection device.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A fluid ejection device comprising:
an ejection nozzle including an ejection nozzle orifice in communication with a printing material chamber, wherein the printing material chamber is to supply printing material to be ejected from the ejection nozzle orifice when the printing material is heated by a printing material ejector; and
a service nozzle including a service nozzle orifice in communication with a service fluid chamber,
wherein the service fluid chamber is to supply service fluid to be ejected from the service nozzle orifice when the service fluid is heated by a service fluid ejector, and
wherein the service nozzle is positioned adjacent the ejection nozzle to enable mixing of the service fluid with the printing material on a surface of the fluid ejection device to at least one of
cool the surface of the fluid ejection device, and
reduce drying of the printing material on the surface of the fluid ejection device.

2. The fluid ejection device according to claim 1, wherein the service fluid ejector is configured to eject the service fluid from the service nozzle orifice at a service fluid ejection velocity that is less than a printing material ejection velocity associated with ejection of the printing material by the printing material ejector.

3. The fluid ejection device according to claim 1, wherein
the service fluid ejector includes a square configuration,
the service nozzle orifice includes a circular configuration, and
a ratio of a side of the service fluid ejector to a diameter of the service nozzle orifice is between approximately 0.2 to approximately 0.8.

4. The fluid ejection device according to claim 1, wherein a shape of the service nozzle orifice is different compared to a shape of the ejection nozzle orifice.

5. The fluid ejection device according to claim 1, wherein a size of the service nozzle orifice is larger compared to a size of the ejection nozzle orifice.

6. A fluid ejection device comprising:
a plurality of ejection nozzles, wherein
each ejection nozzle of the plurality of ejection nozzles includes an ejection nozzle orifice in communication with a corresponding printing material chamber, and
the printing material chamber is to supply printing material to be ejected from the ejection nozzle orifice of a corresponding ejection nozzle when the printing material is heated by a corresponding printing material ejector; and
a plurality of service nozzles, wherein
each service nozzle of the plurality of service nozzles includes a service nozzle orifice in communication with a corresponding service fluid chamber,
wherein the service fluid chamber is to supply service fluid to be ejected from the service nozzle orifice of a corresponding service nozzle when the service fluid is heated by a corresponding service fluid ejector, and
wherein the plurality of service nozzles are positioned adjacent the plurality of ejection nozzles to enable mixing of the service fluid with the printing material on a surface of the fluid ejection device.

7. The fluid ejection device according to claim 6, wherein the service fluid ejector is configured to eject the service fluid from the service nozzle orifice of the corresponding service nozzle at a service fluid ejection velocity that is less than a printing material ejection velocity associated with ejection of the printing material by the printing material ejector.

8. The fluid ejection device according to claim 6, wherein
the service fluid ejector includes a square configuration,
the service nozzle orifice of the corresponding service nozzle includes a circular configuration, and
a ratio of a side of the service fluid ejector to a diameter of the service nozzle orifice is between approximately 0.2 to approximately 0.8.

9. The fluid ejection device according to claim 6, wherein a shape of the service nozzle orifice of the corresponding service nozzle is different compared to a shape of the ejection nozzle orifice of the corresponding ejection nozzle.

10. The fluid ejection device according to claim 6, wherein a size of the service nozzle orifice of the corresponding service nozzle is larger compared to a size of the ejection nozzle orifice of the corresponding ejection nozzle.

11. The fluid ejection device according to claim 6, wherein a service nozzle of the plurality of service nozzles is assigned to a set of the plurality of ejection nozzles to at least one of
cool the surface of the fluid ejection device adjacent to the set of the plurality of ejection nozzles, and
reduce drying of the printing material that remains on the surface of the fluid ejection device adjacent to the set of the plurality of ejection nozzles, wherein the set of the plurality of ejection nozzles includes greater than one ejection nozzle of the plurality of ejection nozzles.

12. A method for printing comprising:
actuating a printing material ejection element of a fluid ejection device;
ejecting, based on the actuation of the printing material ejection element, printing material from an ejection nozzle orifice of an ejection nozzle of the fluid ejection device, wherein
the ejection of the printing material occurs at a printing material ejection velocity;
actuating a service fluid ejection element of the fluid ejection device; and
ejecting, based on the actuation of the service fluid ejection element, service fluid from a service nozzle orifice of a service nozzle of the fluid ejection device, wherein
the ejection of the service fluid occurs at a service fluid ejection velocity, and
the service fluid ejection velocity is less than the printing material ejection velocity to cause the ejected service fluid to at least one of
cool a surface of the fluid ejection device, and
reduce drying of the printing material on the surface of the fluid ejection device.

13. The method according to claim 12, wherein the service fluid ejection element includes a square configuration, and the service nozzle orifice includes a circular configuration, further comprising:
reducing the service fluid ejection velocity by using the service fluid ejection element and the service nozzle orifice for which a ratio of a side of the service fluid ejection element to a diameter of the service nozzle orifice is between approximately 0.2 to approximately 0.8.

14. The method according to claim 12, wherein actuating the service fluid ejection element of the fluid ejection device further comprises:
actuating the service fluid ejection element of the fluid ejection device to cause the service fluid to
eject from the service nozzle orifice that is shaped differently compared to a shape of the ejection nozzle orifice, and
spread on the surface of the fluid ejection device.

15. The method according to claim 12, wherein actuating the service fluid ejection element of the fluid ejection device further comprises:
actuating the service fluid ejection element of the fluid ejection device to cause the service fluid to
eject from the service nozzle orifice that includes a larger size compared to a size of the ejection nozzle orifice, and
spread on the surface of the fluid ejection device.
